(19) United States
(12) Patent Application Publication
(10) Pub. No.: US 2022/0343115 A1
(43) Pub. Date: Oct. 27, 2022

(54) UNSUPERVISED CLASSIFICATION BY CONVERTING UNSUPERVISED DATA TO SUPERVISED DATA

(71) Applicant: Red Hat, Inc., Raleigh, NC (US)

(72) Inventor: Srinivasa Bharath Kanta, Bengaluru (IN)

(21) Appl. No.: 17/242,026

(22) Filed: Apr. 27, 2021

(51) Int. Cl. G06K 9/62

(52) U.S. Cl. CPC G06K 9/6259; G06K 9/6267; G06K 9/6223; G06K 9/6219

(57) ABSTRACT

Systems and methods for providing an unsupervised classification model by converting unsupervised data to supervised data. In one implementation, a processing device can receive an unlabeled dataset comprising one or more data records. The processing device can divide the unlabeled dataset into a plurality of groups. The processing device can then generate, for each group of the plurality of groups, a corresponding label. The processing device can generate a labeled dataset by assigning, to each group of the plurality of groups, the corresponding label. The processing device can then classify the labeled dataset using a classification model.

### TECHNICAL FIELD

The present disclosure is generally related to classification models, and more particular, to unsupervised classification by converting unsupervised data to supervised data.

### BACKGROUND

Classification can be performed by applying machine learning-based techniques. Machine learning is a type of artificial intelligence that automates data processing using algorithms without necessitating the creation of new programs. In other words, machine learning provides data to a computer, and the computer uses that information to analyze future data and learn from experience. Supervised machine learning trains the machine learning model using data that is labeled with a target output.

### BRIEF DESCRIPTION OF THE DRAWINGS

The present disclosure is illustrated by way of example, and not by way of limitation, and can be more fully understood with reference to the following detailed description when considered in connection with the figures in which:

FIG. 1 depicts a block diagram of an example network environment operating in accordance with one or more aspects of the present disclosure.

FIG. 2 depicts a block diagram of a method illustrating converting unlabeled data into labeled data for classification purposes, in accordance with one or more aspects of the present disclosure.

FIG. 3 is a flow diagram of a method for converting unlabeled data to labeled data, in accordance with one or more aspects of the present disclosure.

FIG. 4 depicts a block diagram of an example computer system operating in accordance with one or more aspects of the present disclosure.

FIG. 5 depicts a block diagram of an illustrative computer system operating in accordance with one or more aspects of the present disclosure.

### DETAILED DESCRIPTION

Implementations of the disclosure are directed to unsupervised classification by converting unsupervised data to supervised data. Unsupervised machine learning trains a machine learning model using data that is not labeled with a target output, while supervised machine learning trains the machine learning model using data that is labeled with a target output. Classification can be performed by a supervised machine learning model that predicts a class label for a given data point. A classification model may learn a target function that maps each data point to one of the predefined classes. A classification machine learning model can utilize supervised machine learning, thus mapping input to an output based on known input-output examples. Supervised machine learning models use labeled data. Various classification models rely upon labeled data for training, and thus cannot be trained using unlabeled data.

Aspects of the present disclosure address the above-noted and other deficiencies by implementing an unsupervised classification model that uses unlabeled data as the input by converting the unlabeled data to labeled data. In implementations, a processing device executing an unsupervised classification model may receive an unlabeled dataset containing one or more data records. In embodiments, a processing device may reformat and/or clean the unlabeled dataset prior to inputting the unlabeled dataset to the unsupervised classification model. Cleaning the unlabeled dataset refers to the process of identifying incomplete and/or inaccurate data within the dataset, and replacing, updating and/or deleting the incomplete or inaccurate data. Reformatting the unlabeled dataset (or simply formatting the data) refers to ensuring the data records within the dataset are consistent. In implementations, the processing device can receive data from more than one source, or the data received from a source can be an aggregation of data from multiple sources. The processing device can reformat the data to ensure consistency among the data records within the received dataset. The processing device can then send the cleaned and/or reformatted unlabeled dataset to the unsupervised classification model.

The unsupervised classification model may determine a number of groups in which to divide the dataset. In some embodiments, the number of groups can be received from a user, for example, along with the received dataset input. Alternatively, the model can determine the number of groups using the elbow method, which involves plotting the variation of the dataset as a function of the number of clusters, and utilizing the elbow of the resulting curve (i.e., the point at which adding another cluster would not result in improved modeling of the dataset) as the target number of clusters.

The unsupervised classification model may implement a clustering algorithm to assign each data record of the dataset to one or more of the groups based on similarities between the data records that are assigned to the same group. The clustering algorithm used may depend on the nature of the dataset and/or based on user preference. If the dataset is numerical, the unsupervised classification model may use a clustering algorithm that works better with numerical data (e.g., k-means clustering). On the other hand, if the input data is categorical (e.g., text-based), the unsupervised classification model may use a clustering algorithm that works better with categorical data (e.g., k-modes clustering). Additionally or alternatively, the user may specify the clustering algorithm to use. The clustering algorithm may be a soft clustering algorithm or a hard clustering algorithm. A hard clustering algorithm is one in which each data record is included in only one cluster, whereas a soft clustering algorithm allows for a data record to belong to more than one cluster.

In implementations, the processing device may generate a label for each group, which would represent the target output label for each data record assigned to the group. The label may be randomly generated, may be selected from a predetermined list of labels, or may be a sequential integer value, for example. In implementations, the model may add a data field (e.g., a column in a spreadsheet) that includes the newly assigned label(s) to each record in the dataset. Now that the dataset is labeled, the dataset can be used as input to a classification model.

An example of an unlabeled dataset used as input to the unsupervised classification model described herein can be data related to a bug tracking system. A bug tracking system can detect, record, report, and/or track bugs (e.g., defects) in a software application. The bug tracking system data can include a description of the defect, the time the defect was reported, the severity of the problem, and/or a description of how to reproduce the defect. The bug tracking system data can include additional information not listed here. The bug tracking system data can be unlabeled as it does not have a target output label that can be used in a conventional classification model. For example, the bug tracking system data can be include defects related to Python code, defects related to Java code, and defects related to the integration of Python and Java code, but the bug tracking system data may not include a data field clearly identifying the defects using these groups. It can be very difficult to identify which bug relates to which group (e.g., Java code, Python code, or the integration of Python and Java code). Additionally, while three groups are illustrated in this example, datasets can include any number of groups (usually much more than three groups). Aspects of the present disclosure can convert the bug tracking system data to labeled data by using text mining or clustering techniques to create groups of data and assigning labels to the groups. Once the bug tracking system data has assigned labels, it is converted to labeled data, and can be classified using supervised classification techniques.

In embodiments, the size of the dataset can be so big as to render the methodology described herein inefficient. In such situations, the unsupervised classification model may perform the methodology described herein on a subset of the dataset. The processing device may use one of a number of sampling techniques to identify the subset of data records within the dataset. The sampling technique used should result in a subset that includes all classes of data in almost equal proportion. That is, the sample (or subset of the dataset) should be representative of the original dataset. Sampling techniques that can be used include simple random sampling, systematic sampling, stratified sampling, convenience sampling, quota sampling, judgment sampling, etc. The sampling technique can be adaptive (sometimes referred to as progressive), which increases the sample size as more data is received. Once the processing device has identified a representative subset of the dataset, the processing device can send the representative subset as input to the unsupervised classification model. The unsupervised classification model can perform the methodology described herein on the subset. That is, the unsupervised classification model can divide the subset into a plurality of groups, generate corresponding labels for each group, generate a labeled subset of the dataset by assigning a corresponding label to each group, and provide the labeled subset of the dataset as input to a classification model.

Aspects of the present disclosure present advantages over conventional classification models by enabling unlabeled data to be used as input to the unsupervised classification model. Implementations of the present disclosure present disclosure provide an efficient classification model for unlabeled data over other solutions because the labels assigned to the groups are randomly generated or selected from a preexisting list of label, thus reducing latency of the unsupervised classification model. The unsupervised classification model described herein may enhance the functioning of the computer on which it is running by enhancing the speed and efficiency of the application using the model, resulting in faster processing times.

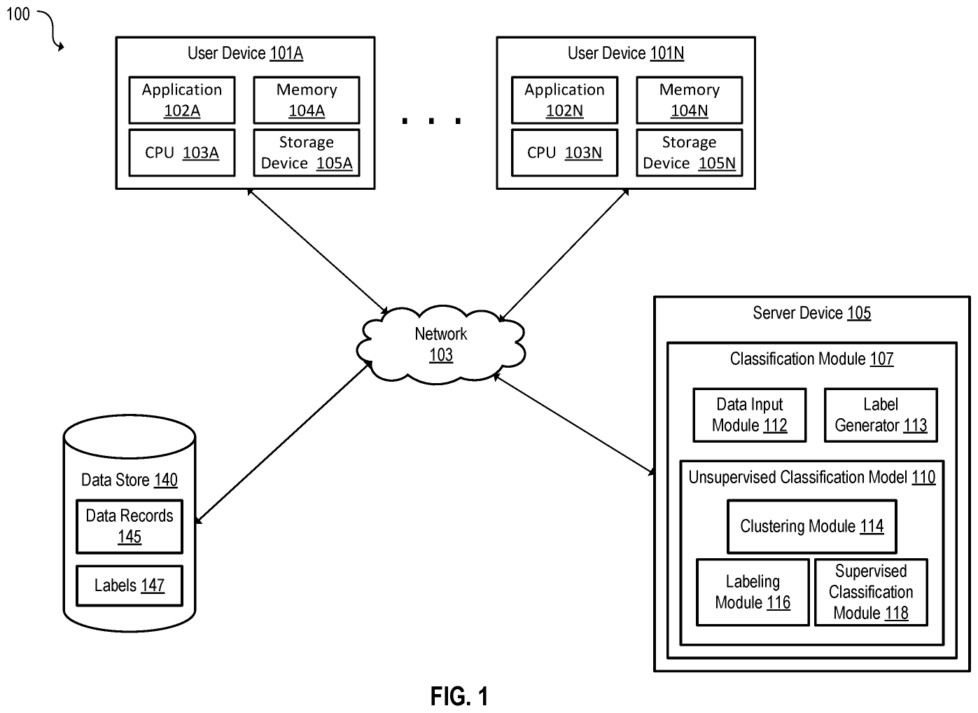

FIG. 1 is a block diagram that illustrates a sample network environment 100, in accordance with one or more aspects of the present disclosure. The network environment 100 can include one or more user devices 101A-101N, a data store 140, and a server device 105. The one or more user devices 101A-101N, the data store 140, and the server device 105 can be communicably connected over a network 103. The network 103 can be a private network (e.g., a local area network (LAN), a wide area network (WAN), intranet, etc.) or a public network (e.g., the Internet).

The user devices 101A-101N and/or the server device 105 can be a server, a workstation, a personal computer (PC), a mobile phone, a smart phone, a mobile computing device, a personal digital assistant (PDA), tablet, laptop computer, thin client, etc. The user devices 101A-101N and the server device 105 can each include one or more applications 102A-102N, one or more central processing units (CPUs) 103A-103N, memory 104A-104N, storage devices 105A-105N, and/or peripheral physical devices (not illustrated). The physical devices can be any type of devices, including a data storage device or mass storage device, such as a magnetic or optical storage based disk, tape or hard drive. Other examples of physical devices can include network devices, graphics devices, system components (e.g., bridges, ports, buses) media devices, (e.g., video cards, sounds cards, etc.).

In some embodiments, the application 102A-102N can aggregate data records to be classified. In an illustrative example, application 102A-102N can be a bug tracking system used to detect, record, report, and/or track bugs (e.g., defects) in other software applications installed on user devices 101A-101N. The bug tracking system can collect data relating to the detected defects, such as a description of the defect, the time the defect was reported, the severity of the problem, a description of how to reproduce the defect, etc. The application 102A-102N can store the bug tracking data on storage device 105A-105N and/or on data store 140. Developers can use the bug tracking data to rectify the defects identified in the software. In order to facilitate the debugging process, developers may want to classify the debug data received from the bug tracking system. In implementations, the application 102A-102N can send the bug tracking data to the server device 105 to classify the bug tracking data, and/or can send an instruction to server device 105 to classify the bug tracking data stored on data store 140.

Data store 140 can store multiple data records 145 and labels 147, and can be accessed by user devices 101A-101N and server device 105 over one or more networks 103. Data records 145 and/or labels 147 can be stored as one or more tables, spreadsheets, databases, distributed data stores, or other data structure. In one embodiment, data store 140 can store one or more data records 145 as a table, where each record is represented as a row and each data field is represented as a column. In embodiments, labels 147 can be a list of label names, which can be received from a user device 101A-101N, or generated by server device 105.

The server device 105 can include a classification module 107 that can include a data input module 112, a label generator 113, and an unsupervised classification model 110, which can include a clustering module 114, a labeling module 116, and a supervised classification module 118. Note that in alternative embodiments, the server device 105 and/or the unsupervised classification model 110 may include more or less modules than those shown in FIG. 1. Also, one or more of the data input module 112 and/or the label generator 113 may be combined into a single module. Furthermore, one or more of the clustering module 114, the labeling module 116, and/or the supervised classification module 118 may be combined into a single module. Additionally, the functionality of any of the data input module 112, the label generator 113, the clustering module 114, the labeling module 116, and/or the supervised classification module 118 may be divided between multiple modules.

The data input module 112 can receive unlabeled data from one or more user devices 101A-101N. For example, user devices 101A-101N can be running bug tracking system software application 102A-102N, which collects data related to defects detected within the respective user device. The bug tracking system can collect bug tracking data from a user of a piece of software and/or from a tester of the same software. User devices 101A-101N can send bug tracking data to server device 105, either automatically or responsive to a command. The bug tracking data can include a description of the detected defect (or bug), a date and timestamp of the detected defect, instructions on how to recreate the defect, and so on.

The data input module 112 can receive the unlabeled dataset(s) from the user devices 101A-101N and can store the received dataset(s) in data store 140. Each dataset can include one or more data records 145. The data input module 112 can clean and reformat the data records 145. Cleaning the data can refer to the process of identifying incomplete, inaccurate, incorrect, missing, and/or irrelevant data within the dataset(s), and replacing the identified data with corrected data records. For example, the data input module 112 can identify outliers within the dataset(s). An outlier can be a data record that differs significantly from the other data records within the dataset. The data input module 112 can replace the identified outlier(s) with a mean or median value, or the data input module 112 can remove the outlier data record(s) altogether. For example, if the receive dataset includes an age data field, and one of the data records has an age of 235, the data input module 112 can either delete that data record or replace the age data field with a mean age value or median age value. In embodiments, the data input module 112 can also standardize and/or normalize the data records. Standardization is a scaling technique in which the values of data records are centered on the mean with a unit standard deviation. Normalization involves structuring data according to one or more norms. For example, normalization can include min-max scaling, which is a scaling technique in which the values are adjusted to be between 0 and 1. Other examples of normalization include z-score normalization, which normalizes data based mean and standard deviation, and decimal scaling normalization, which normalizes data by moving the decimal point of data. The data input module 112 can use other applicable cleaning and reformatting techniques on the received dataset(s). The data input module 112 can store the cleaned and/or reformatted dataset(s) in the data store 140, either as updated data records 145 or as a separate data structure (not illustrated).

The data input module 112 can also reduce the received unlabeled dataset(s) using one of a number of sampling techniques. If the size of the received dataset exceeds a size threshold criteria, the data input module 112 can implement a sampling technique to identify a sample (or subset) of the received dataset. The data input module 112 can store the subset in data store 140, for example, as a separate data structure (not illustrated). The data input module 112 can receive an instruction from user device 101A-101N specifying a sampling technique to use, or the data input module 112 can determine an appropriate sampling technique based on the nature of the data records received. In embodiments, the data input module 112 can receive a number of approved sampling techniques from a user device 101A-101N and can determine, among the number of approved sampling techniques, which one to use based on the nature of the data. The sampling technique used should result in a high probability of generating a representative sample, i.e., one that has approximately the same property of interest as the original dataset.

The clustering module 114 can use a clustering algorithm to assign each data record (either of the entire dataset or of the subset identified by the data input module 112) to one or more groups based on the similarities between the data records that are assigned to the same group. The clustering algorithm 114 can receive input from one or more of the user devices 101A-101N indicating the number of groups in which to divide the data. Alternatively, the clustering module 114 can determine how the number of groups in which to divide the data, for example, by using the elbow method. The elbow method involves plotting the explained variation of the data as a function of the number of groups, and utilizing the elbow of the resulting curve (i.e., the point at which adding another group would not result in improved modeling of the data) as the target number of groups. Once the number of groups exceeds the actual number of groups in the dataset, additional groups are merely subdividing the actual groups in the dataset, thus no longer providing additional useful information.

The clustering module 114 can then use a clustering algorithm to divide the unlabeled data records into the determined number of groups. If the data input module 112 implemented a sampling technique to identify a subset of the dataset, the clustering module 114 can use a clustering algorithm to divide the data records in the identified subset of the dataset. The clustering module 114 may receive an instruction from user device 101A-101N specifying which clustering algorithm to use, or the clustering module 114 can determine the appropriate clustering algorithm to use based on the nature or size of the data records, for example. For numerical data, the clustering module 114 may use a clustering algorithm that works better with numerical data, such as k-means clustering. For categorical data (e.g., text-based data), the clustering module 115 may use a clustering algorithm that works better with categorical data (e.g., k-modes clustering). Other clustering algorithms that can be used include agglomerative hierarchal clustering, density-based (DBSCAN) clustering, and more.

The clustering algorithm used can be exclusive, or overlapping or non-exclusive. An exclusive algorithm places the data points in one of the clusters resulting in hard clusters, whereas a non-exclusive algorithm can place a data point in more than one cluster resulting in soft clusters. The clustering module 114 may receive an instruction from user device 101A-101N specifying whether to enable soft clustering. The default setting of clustering module 114 can be to disable soft clustering, but soft clustering may be enabled based on user preference and/or based on the nature of the dataset.

The label generator 113 can generate a list of labels and store the list in labels 147 of data store 140. In some embodiments, the label generator 113 can generate a random list of labels using a random generator algorithm. The random generator algorithm can ensure that the list of labels is not repetitive, i.e., that no two labels in the list are alike. For example, the label generator 113 may generate unique 6-digit labels until every 6-digit combination has been used once, and then may begin generating unique 7-digit labels. In embodiments, the label generator 113 can generate a list of labels based on sequential integer values. For example, the label generator 113 may begin the label list with an integer value (e.g., “1,” or may begin the list with a letter following by an integer value, e.g., “c1”), and may increment the integer value for each additional label (e.g., “2” or “c2,” “3” or “c3,” etc.). The label generator 113 can generate a list of labels prior to the labeling modeling 116 assigning labels to the data records. In embodiments, the label generator 113 can generate a list containing a label for each of the determined number of groups, and can store the generated list of labels in labels 147. For example, if clustering algorithm 114 divided the unlabeled data records into 15 groups, the label generator 113 can generate a list of 15 labels. Additionally or alternatively, the label generator 113 can generate new labels on demand. For example, label generator 113 can generate a label as labeling module 116 is assigning labels to the groups created by clustering module 114. That is, as labeling module 116 is assigning labels to the groups, labeling module 116 can request a label from label generator 113. Label generator 113 can then create a new label following an existing label generation technique, i.e., a randomly generated label, or a sequential label.

The labeling module 116 can assign a label to each data record in the dataset (or in the subset identified by the data input module 112). The labels can be generated by label generator 113 (either on demand or pre-generated), or the list of labels stored in 147 can be predefined, e.g., received from user device 101A-101N. In some embodiments, server device 105 can receive a list of labels from user device 101A-101N, and can store the list of labels in labels 147 of data store 140. The labeling module 116 can generate a labeled dataset by assigning a label to each group of data records. Each label can represent one of the groups created by the clustering module 114. The labeling module 116 can add a data field to the data records 145 including the assigned label.

If the clustering algorithm used by clustering module 114 resulted in soft clusters, the labeling module 116 can assign more than one label to each data record. For example, if a data record belongs to two groups as a result of the clustering algorithm, the labeling module 116 can assign two labels, each one representing one of the assigned groups. In embodiments, the clustering module 114 can generate sets of groups in which each set represents a different combination of data records. For example, if data record 1 belongs to class A and class B, the clustering module 114 can generate one set of groups in which class A includes data record 1 and another set of groups in which class B includes data record 1. After assigning labels to the data records, the dataset is converted to a labeled dataset.

The supervised classification module 118 can provide the labeled dataset to a supervised classification model. The classification model can be a supervised classification model because the data has been converted to labeled data, where the newly assigned label is the target output label.

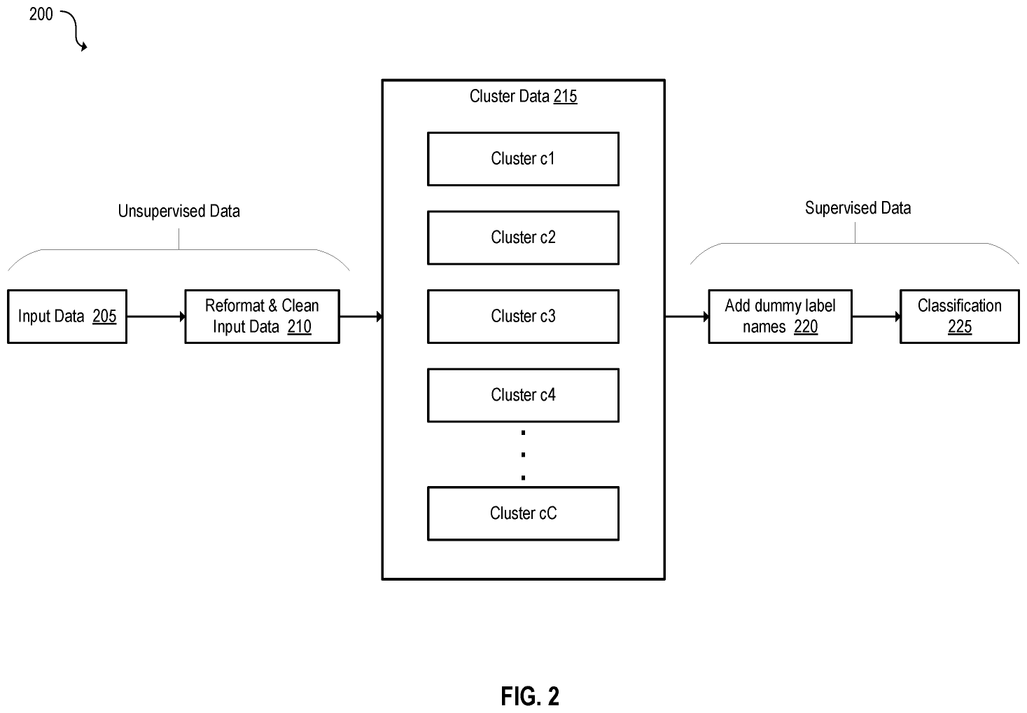

FIG. 2 depicts a block diagram of a method 200 illustrating converting unlabeled data into labeled data for classification purposes, in accordance with one or more aspects of the present disclosure. In some embodiments, method 200 may be implemented by the unsupervised classification model 110 of server device 105 of FIG. 1. Method 200 may be performed by processing logic that includes hardware (e.g., circuitry, dedicated logic, programmable logic, microcode, etc.), software (e.g., instructions run on a processor to perform hardware simulation), or a combination thereof. Method 200 or each of its individual functions, routines, subroutines, or operations may be performed by one or more processors of a computer system (e.g., server device 105 of FIG. 1) implementing the method. In an illustrative example, method 200 may be performed by a single processing thread. Alternatively, method 200 may be performed by two or more processing threads, each thread implementing one or more individual functions, routines, subroutines, or operations of the method. In an illustrative example, the processing threads implementing method 200 may be synchronized (e.g., using semaphores, critical sections, or other thread synchronization mechanisms).

For simplicity of explanation, the methods of this disclosure are depicted and described as a series of acts. However, acts in accordance with this disclosure can occur in various orders and/or concurrently, with other acts not presented and described herein. Furthermore, not all illustrated acts may be needed to implement the methods in accordance with the disclosed subject matter. In addition, it can be appreciated that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or storage media.

In FIG. 2, at block 205, a processing device may receive a set of data that does not contain target output labels, i.e., a set of unlabeled data. The set of data can contain one or more data records. In embodiments, the data records may be rows in a spreadsheet or a table, for example. The data set can be received from one or more user devices, and/or can be accessed directly from a data store.

At block 210, the processing device may reformat and clean the received data set. Reformatting and cleaning the data can involve normalizing the data, removing redundant records, and/or removing or replacing outliers, for example.

At block 215, the processing device may divide the data records into a number of groups using a clustering algorithm. The number of groups in which to divide the data records may be received as input from a user. Alternatively, the processing device may determine a number of groups in which to divide the data records using the elbow method. The elbow method is a known method that determines the number of clusters in a dataset that involves plotting the variation of the dataset as a function of the number of clusters, and utilizing the elbow of the resulting curve (i.e., the point at which adding another cluster would not result in improved modeling of the dataset) as the target number of clusters.

The processing device may use known clustering algorithms to divide the data records, such as k-means clustering, spatial clustering of applications with noise (DBSCAN), hierarchal clustering, etc. The clustering algorithm used may depend on the nature of the input data. For example, if the input data is numerical data, the processing device may use a clustering algorithm that works better with numerical data (e.g., k-means). On the other hand, if the input data is categorical, the processing device may use a clustering algorithm that works better with categorical data (e.g., k-modes). Alternatively, the processing device may receive, from a user device, an instruction specifying which clustering algorithm to use.

At block 220, the processing device may then assign a label to each of the data records based on the groups. The labels may be randomly generated, selected from an existing list of predefined labels, or may be sequential integer numbers, for example. For example, if the processing device divided the data set into C number of clusters, the processing device may assign the label “c1” to the data records belonging to the first cluster, the label “c2” to the data records belonging the second cluster, and so on. In embodiments, the processing device may add a column to the data set, wherein the column contains the dummy label of each corresponding data record.

In embodiments, the clustering technique may have divided the data set into soft clusters. The processing device may receive a user input indicating a user preference regarding whether to allow soft clusters or not. By allowing soft clusters, a data record may be present in more than one cluster, and as such may have two (or more) labels assigned to it. Hard clusters, on the other hand, result in each data record being assigned to one cluster.

Once the processing device has assigned labels to the one or more data records within the data set, the data set is converted to labeled data (i.e., data that is labeled with a target output). At block 225, the processing device can train a classification model using the data set. That is, the processing device can input the labeled dataset to a classification model to train the classification model. The processing device can generate a trained classification model that classifies the data based on the newly assigned output target labels.

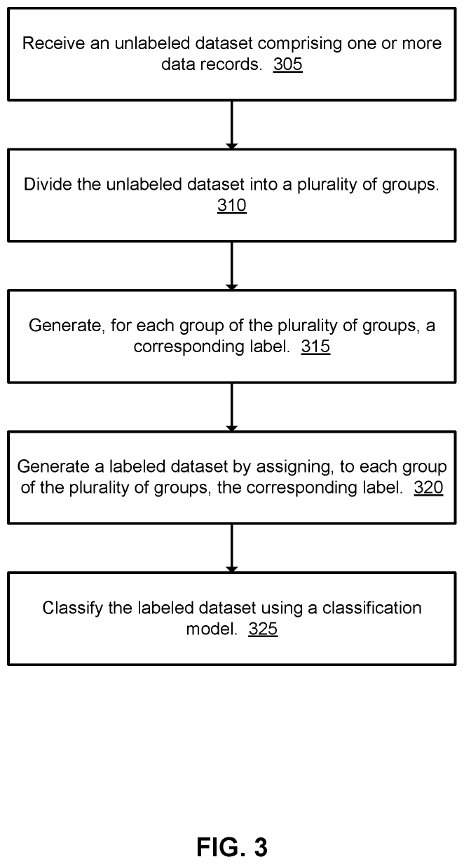

FIG. 3 depicts a flow diagram of an example method 300 for converting unlabeled data to labeled data, in accordance with one or more aspects of the present disclosure. Method 300 may be performed by processing logic (e.g., in computer system 100 of FIG. 1) that may comprise hardware (e.g., circuitry, dedicated logic, programmable logic, microcode, etc.), software (such as instructions run on a processing device), firmware, or a combination thereof. In one embodiment, method 300 is performed primarily by a server device 105 of FIG. 1.

For simplicity of explanation, the methods of this disclosure are depicted and described as a series of acts. However, acts in accordance with this disclosure can occur in various orders and/or concurrently, with other acts not presented and described herein. Furthermore, not all illustrated acts may be needed to implement the methods in accordance with the disclosed subject matter. In addition, it can be appreciated that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or storage media.

At block 305, the processing logic of a server device may receive an unlabeled dataset comprising one or more data records. That is, the records in the dataset do include a target output label that can be used in conventional classification models. The dataset may be a spreadsheet or table, where each data record is one row, and each data field of a data record is a column. In an illustrative example, the unlabeled dataset is related to a bug tracking system, and the one or more data records include at least one of a description of a corresponding bug, a time of the corresponding bug, a severity of the corresponding bug, or an instruction on how to reproduce the corresponding bug.

At block 310, the processing logic may divide the unlabeled dataset into a plurality of groups. In some embodiments, the processing logic may determine the number of groups in which to divide the dataset using the elbow method, i.e., by identifying an elbow of a variation of the unlabeled dataset as a function of the number of groups. In some embodiments, the processing logic may receive the number of groups. For instance, the processing logic may receive, from a user device, the specific number of groups in which to divide the dataset.

The processing logic may divide the data into the plurality of groups by applying a clustering algorithm. The clustering algorithm can be k-means clustering, density-based spatial clustering of applications with noise (DBSCAN), agglomerative hierarchical clustering, or another appropriate clustering algorithm. The processing logic may select the appropriate clustering algorithm based on user preference, or based on the nature of the data records in the dataset.

The clustering algorithm may result in soft-type clusters or hard-type clusters. The type of clusters may be determined by input received from a user device. That is, a user may provide an instruction enabling or disabling soft-type clusters. In embodiments, the model may have a default setting enabling soft-type clusters. In embodiments in which soft-type clusters are enabled, the processing logic may determine whether any of the data records belong to more than one group. Responsive to determining that a data record is associated with two or more groups, the processing logic may assign the corresponding label associated with the two or more groups to the data record. That is, the data record may receive more than one label, where each label is associated with a different group that the data record belongs to. Furthermore, responsive to determining that a data record is associated with two or more groups, the processing logic may divide the dataset into a plurality of sets of groups. Each set of groups can include a different combination of data records.

For example, if Data Record 1 belongs group A and to group B, and Data Record 2 belongs to group B and to group C, the processing logic can great a first set of groups in which group A includes Data Record 1, group B includes Data Record 2, and group C is empty; a second set of groups in which group A is empty, group B includes Data Record 1 and Data Record 2, and group C is empty; a third set of groups in which group A is empty, group B includes Data Record 1, and group C includes Data Record 2; and a fourth set of groups in which group A includes Data Record 1, group B is empty, and group C includes Data Record 2. The classification model can be trained using each set of groups, or any combination of sets of groups.

At block 315, the processing logic may generate, for each group of the plurality of groups, a corresponding label. The labels can be randomly generated, or can be sequential integer values.

At block 320, the processing logic may generate a labeled dataset by assigning, to each group of the plurality of groups, the corresponding label. In embodiments, the processing logic may add a data field to the one or more data records. The added data field can include the label(s) assigned to the respective data record. In implementations, the dataset can be in a spreadsheet format, where each row represents one data record. The processing logic may add a column to the spreadsheet in which to store the assigned label of each data record. At block 325, the processing logic may classify the labeled dataset using a classification model.

In some embodiments, the processing logic may determine that the size of the unlabeled dataset satisfies a threshold criteria. The threshold criteria can be a certain maximum size limit. Responsive to determining that the size of the dataset satisfies the threshold criteria (e.g., the size of the dataset exceeds a certain maximum size limit), the processing logic may identify a subset of the unlabeled dataset using a sampling algorithm. The processing logic may determine the sampling algorithm to use based on user preference, or based on the nature of the data records in the dataset. The sampling technique used should result in a high probability of generating a representative sample. Sampling techniques include simple random sampling, systematic sampling, stratified sampling, convenience sampling, quota sampling, judgment sampling, etc. The sampling technique can be adaptive or progressive, which increase the sample size as more data is received. Once the processing logic has reduced the dataset using a sampling algorithm, the processing logic can perform the operations of blocks 310 through 325 on the identified subset of the unlabeled dataset.

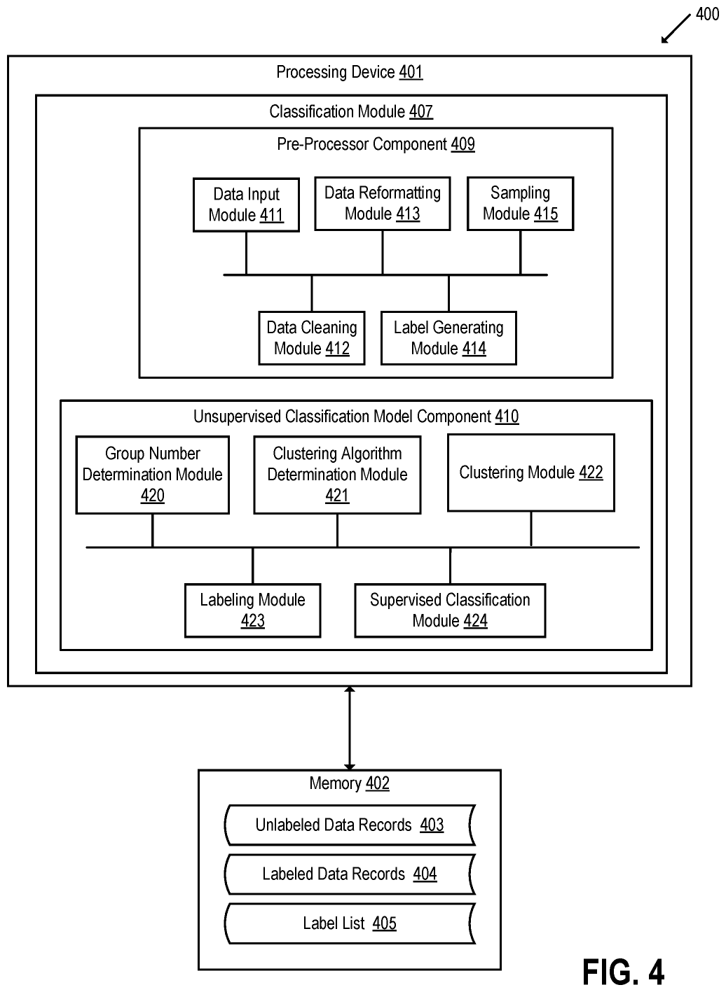

FIG. 4 depicts a block diagram of an example computer system 400 operating in accordance with one or more aspects of the present disclosure. Computer system 400 may perform the same functions as server device 105 of FIG. 1, and may include one or more processing devices 401, and one or more memory devices 402. In the example shown, the processing device 401 of computer system 400 may include a classification module 407. Classification module 407 may perform the same functions as classification module 107 described with respect to FIG. 1. In the example shown, the memory device 402 includes one or more unlabeled data records 403, one or more labeled data records 404, and/or one or more label list(s) 405. Each data record in unlabeled data records 403 and labeled data records 404 can include one or more data fields.

The classification module 407 may include a pre-processor component 409 and an unsupervised classification model component 410. The pre-processor component 409 may receive data from one or more sources (e.g., from one or more user devices) and may perform pre-processing operations on the received data. The pre-processor component 409 can include a data input module 411, a data cleaning module 412, a data reformatting module 413, a label generating module 414, and a sampling module 415. The data input module 411 can receive unlabeled dataset(s) from one or more user sources. The unlabeled dataset(s) can include one or more data records. The data input module 411 can store the received data records in unlabeled data records 403 of memory 402.

Data cleaning module 412 can clean the unlabeled data records 403 by identifying incomplete, inaccurate, incorrect, missing, and/or irrelevant data records. Data cleaning module 412 can replaced the identified data records with “clean” data records by replacing the incomplete, inaccurate, incorrect, missing and/or irrelevant data fields with complete, accurate, correct, placeholder, and/or relevant data fields. In embodiments, the data cleaning module 412 can delete the identified incomplete, inaccurate, incorrect, missing, and/or irrelevant data records. The data cleaning module can also identify outlier data fields and delete the corresponding data record, or can replace the identified outlier data fields with a placeholder value. A placeholder value can be a mean, median, or mode value, for example.

The data reformatting module 413 can reformat the unlabeled data records 403 to ensure consistency among the data fields, including standardizing and/or normalizing the unlabeled data records 403. In embodiments, data reformatting module 413 can standardize the unlabeled data records 403 by rescaling one or more data fields to ensure the mean and the standard deviation are 0 and 1, respectively. In embodiments, data reformatting module 413 can normalize the unlabeled data records 403 by rescaling one or more data fields. For example, using min-max normalization, data reformatting module 413 can normalize the unlabeled data records 403 by rescaling one or more of the data fields to be between 0 and 1. Another example of normalization is decimal scaling, in which the data reformatting module 413 can normalize the unlabeled data records 403 by moving the decimal point of the data in one or more of the data fields. Another example of normalization is z-score normalization, in which the data reformatting module 413 can normalize the unlabeled data records 403 based on the mean and standard deviation of one or more of the data fields. Data reformatting module 413 can use any of these normalization techniques and/or additional normalization techniques not described here, either alone or in combination.

The label generating module 414 can generate one or more label lists and store the list(s) in label list 405 of memory 402. In embodiments, the data input module 411 can receive one or more label lists as input and store the received list(s) in label list 405 of memory 402. Additionally or alternatively, label generating module 414 can generate one or more lists of labels using a number of techniques. Label generating module 414 can generate a list of labels based on a random generator, in which the labels do not repeat. The labels can be numbers, letters, and/or a combination of letters and numbers. Label generating module 414 can generate a list of labels based on sequential integer values, for example, starting with 1 and incrementing by a set value (e.g., by 1) for each label. The list of labels can begin with one or more letters followed by the integer value (e.g., “c1,” “c2,” “c3,” etc.). Label generating module 414 can generate one or more lists of labels 405 prior to or in conjunction with the unlabeled data records 403 being converted to labeled data records 404. Additionally or alternatively, label generating module 414 can generate one or more labels on demand. That is, labeling module 423 of unsupervised classification model component 410 can request a label from label generating module 414, for example if label list 405 is empty or does not have any available (e.g. unused) labels. Label generating module 414 can then generate a new label following the labeling technique (e.g., random, sequential, etc.) in response to a request from labeling module 423.

The sampling module 415 can execute a sampling technique to identify a sample (or subset) of the unlabeled data records 403. In some embodiments, the size of the received dataset may be so big as to render the unsupervised classification model component 410's operations inefficient. If the size of the received dataset satisfies a threshold condition (e.g., exceeds a threshold size limit), the sampling module 415 identify a representative sample using a sampling technique. The classification module 407 may receive (e.g., as input from a user device) an instruction specifying which sampling technique to use, or the sampling module 415 can determine an appropriate sampling technique based on the nature of the dataset. The sampling technique used should result in a high probability of generating a representative sample, i.e., one that has approximately the same property of interest as the original dataset. The sampling module 415 can store the identified subset of the unlabeled data records in memory 402, and can send the identified subset to the unsupervised classification model component 410.

The unsupervised classification model component 410 can convert the unlabeled data records 403 to labeled data records 404 in order to use the labeled data records 404 as input in a supervised classification model. The unsupervised classification model component 410 can include a group number determination module 420, a clustering algorithm determination module 421, a clustering module 422, a labeling module 423, and a supervised classification module 424. The group number determination module 420 can determine the number of groups in which to divide the unlabeled data records 403. In some embodiments, the classification module 407 can receive the number of groups in which to divide the unlabeled data records 403 as input, and the group number determination module 420 can use the received number as the number of groups in which to divide the unlabeled data records 403. Alternatively, the group number determination module 420 can use the elbow method, which involves plotting the variation of the unlabeled data records as a function of the number of groups, and utilizing the elbow of the resulting curve (i.e., the point at which adding another group would not result in improved modeling of the unlabeled data records) as the target number of groups.

The clustering algorithm determination module 421 can determine an appropriate clustering algorithm to use on the unlabeled data records 403. In some embodiments, the classification module 407 can receive an instruction specifying which clustering algorithm to use, and/or can receive a list of approved clustering algorithms to use. The clustering algorithm determination module 421 can select a clustering algorithm from the approved list, or can select any clustering algorithm. The clustering algorithm determination module 421 can select the clustering algorithm based on the nature and/or size of the unlabeled data records 403 in the received dataset. For example, if the dataset is numerical, the unsupervised classification model may use a clustering algorithm that works better with numerical data (e.g., k-means clustering). On the other hand, if the input data is categorical (e.g., text-based), the unsupervised classification model may use a clustering algorithm that works better with categorical data (e.g., k-modes clustering). The clustering algorithm may be a soft clustering algorithm or a hard clustering algorithm. A hard clustering algorithm is one in which each data record is included in only one cluster, whereas a soft clustering algorithm allows for a data record to belong to more than one cluster. In some embodiments, the default can be to disable soft clustering (thus only allowing hard clustering algorithms), and the classification module 407 can receive an instruction (e.g., from a user device) specifying whether to enable soft clustering.

The clustering module 422 can execute the determined clustering algorithm on the unlabeled data records 403. The clustering module 422 can divide the data records into the number of groups determined by the group number determination module 420 using the clustering algorithm selected by the clustering algorithm determination module 421.

The labeling module 423 can assign to each unlabeled data record 403 in each group a corresponding label. The labeling module 423 can select a label from label list 405 for each group generated by clustering module 422. In embodiments, the labeling module 423 can request a label for one or more groups from label generating module 414 (for example, if label list 405 is empty or does not have sufficient unused labels). Once the labeling module 423 has assigned a label from label list 405 to a group, the labeling module 423 can mark the label in label list 405 as used to avoid reusing labels for more than one group.

In an illustrative example, if clustering module 422 divided unlabeled data records 403 into five groups, labeling module 423 can label the five groups sequentially as c1, c2, c3, c4, and c5. The labels may have been stored in label list 405, either as a predefined list received as input (e.g., from a user device) or as a pre-generated list generated by label generating module 414. The labels may have been generated in response to a request from labeling module 423. If soft clustering is enabled and one or more of the unlabeled data records 403 are in more than one group, the labeling module 423 can assign more than one label to the unlabeled data records 403. For example, if data record belongs to group c1 and to group c2, labeling module 423 can label data record 1 with both c1 and c2. In embodiments, labeling module 423 can generate more than one set of unlabeled data records 403 in which each set contains a different combination of data records (e.g., one set would have data record 1 with the label c1, and another set would have data record 1 with the label c2).

Once labeling module 423 has assigned labels to unlabeled data records 403 based on the groups generated by the clustering module 422, the data records can be stored as labeled data records 404. The supervised classification module 424 can provide the labeled data records 404 to a supervised classification model.

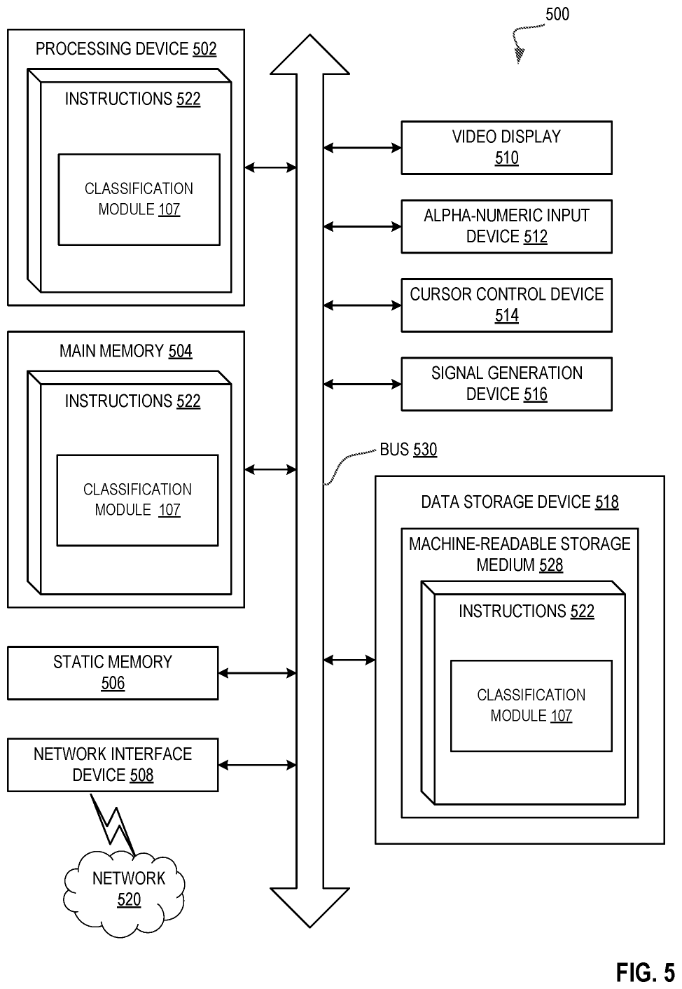

FIG. 5 is a diagrammatic representation of a machine in the exemplary form of a computer system 500 within which a set of instructions for causing the machine to perform any one or more of the methodologies discussed herein may be executed. In various illustrative examples, computer system 500 may correspond to computer system 100 of FIG. 1. Computer system 500 may be included within a data center that supports virtualization. Virtualization within a data center results in a physical system being virtualized using virtual machines to consolidate the data center infrastructure and increase operational efficiencies. A VM may be a program-based emulation of computer hardware resources associated with hard disks or other such memory. The VM may emulate a physical computing environment, but requests for a hard disk or memory may be managed by a virtualization layer of a host machine to translate these requests to the underlying physical computing hardware resources. This type of virtualization results in multiple VMs sharing physical resources.

In certain embodiments, computer system 500 may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. Computer system 500 may be provided by a personal computer (PC), a tablet PC, a set-top box (STB), a personal digital assistant (PDA), a cellular telephone, a web appliance, a server, a network router, switch or bridge, or any machine capable of executing a set of instructions (sequential or otherwise) that specify actions to be taken by that device. Further, while only a single machine is illustrated, the term “computer” shall also be taken to include any collection of computers that individually or jointly execute a set (or multiple sets) of instructions to perform any one or more of the methodologies discussed herein.

The example computer system 500 may include a processing device 502, a main memory 504 (e.g., read-only memory (ROM), flash memory, dynamic random access memory (DRAM) (such as synchronous DRAM (SDRAM), etc.), a static memory 506 (e.g., flash memory, static random access memory (SRAM), etc.), and a data storage device 518, which communicate with each other via a bus 530.

Processing device 502 represents one or more general-purpose processing devices such as a microprocessor, central processing unit, or the like. More particularly, the processing device may be complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets. Processing device 502 may also be one or more special-purpose processing devices such as an application specific integrated circuit (ASIC), a field programmable gate array (FPGA), a digital signal processor (DSP), network processor, or the like. Processing device 502 may be configured to execute the classification module 107 for programming the operations and steps discussed herein.

Computer system 500 may further include a network interface device 508. Computer system 500 may also include a video display unit 510 (e.g., a liquid crystal display (LCD) or a cathode ray tube (CRT)), an alphanumeric input device 512 (e.g., a keyboard), a cursor control device 514 (e.g., a mouse), and a signal generation device 516 (e.g., a speaker).

Data storage device 518 may include a machine-readable storage medium (or more specifically a computer-readable storage medium) 528 having one or more sets of instructions 522 (e.g., the classification module 107) embodying any one or more of the methodologies of functions described herein. The classification module 107 may also reside, completely or at least partially, within main memory 504 and/or within processing device 502 during execution thereof by computer system 500; main memory 504 and processing device 502 also constituting machine-readable storage media. The classification module 107 may further be transmitted or received over a network 520 via network interface device 508.

Machine-readable storage medium 528 may also be used to store the device queue manner logic persistently. While machine readable storage medium 528 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing or encoding a set of instruction for execution by the machine and that causes the machine to perform any one or more of the methodologies of the present disclosure. The term “machine-readable storage medium” shall accordingly be taken to include, but not limited to, solid-state memories, and optical and magnetic media.

The components and other features described herein can be implemented as discrete hardware components or integrated in the functionality of hardware components such as ASICs, FPGAs, DSPs or similar devices. In addition, these components can be implemented as firmware or functional circuitry within hardware devices. Further, these components can be implemented in any combination of hardware devices and software components.

Some portions of the detailed descriptions are presented in terms of methods and symbolic representations of operations on data bits within a computer memory. These descriptions and representations are the means used by those skilled in the data processing arts to most effectively convey the substance of their work to others skilled in the art. A method is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the above discussion, it is appreciated that throughout the description, discussions utilizing terms such as “enabling,” “transmitting,” “requesting,” “identifying,” “querying,” “retrieving,” “forwarding,” “determining,” “passing,” “processing,” “issuing,” “measuring,” “caching,” “monitoring,” mapping,” “estimating,” “calculating,” “disabling,” “detecting,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments also relate to an apparatus for performing the operations herein. This apparatus may be specially constructed for the required purposes or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs and magnetic-optical disks, read-only memories (ROMs), random access memories (RAMs), erasable programmable ROMs (EPROMs), electrically erasable programmable ROMs (EEPROMs), magnetic or optical cards, flash memory devices including universal serial bus (USB) storage devices (e.g., USB key drives) or any type of media suitable for storing electronic instructions, each of which may be coupled to a computer system bus.

The methods and illustrative examples described herein are not inherently related to any particular computer or other apparatus. Various general purpose systems may be used with programs in accordance with the teachings herein or it may prove convenient to construct more specialized apparatus to perform the required method 300, and/or each of their individual functions, routines, subroutines or operations. Examples of the structure for a variety of these systems are set forth in the description above.

It is to be understood that the above description is intended to be illustrative, and not restrictive. Many other embodiments will be apparent to those of skill in the art upon reading and understanding the above description. Although the present disclosure has been described with reference to specific exemplary embodiments, it will be recognized that the disclosure is not limited to the embodiments described, but can be practiced with modification and alteration within the spirit and scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

What is claimed is:

1. A method comprising:
receiving an unlabeled dataset comprising one or more data records;
dividing the unlabeled dataset into a plurality of groups;
generating, for each group of the plurality of groups, a corresponding label;
generating a labeled dataset by assigning, to each group of the plurality of groups, the corresponding label; and
classifying the labeled dataset using a classification model.

2. The method of claim 1, further comprising:
determining a number of the plurality of groups by identifying an elbow of a variation of the unlabeled dataset as a function of the number of groups.

3. The method of claim 1, wherein dividing the unlabeled dataset into the plurality of groups further comprises:
responsive to determining that a data record is associated with two or more groups, dividing the unlabeled dataset into a plurality of sets of groups, wherein each set of the plurality of sets of groups comprises a different combination of data records.

4. The method of claim 1, wherein dividing the unlabeled dataset into the plurality of groups further comprises: applying at least one of k-means clustering, density-based spatial clustering of applications with noise (DBSCAN), or agglomerative hierarchical clustering.

5. The method of claim 1, wherein generating the labeled dataset by assigning, to each group of the plurality of groups, the corresponding label further comprises:
responsive to determining that a data record is associated with two or more groups, assigning the corresponding labels associated with the two or more groups to the data record.

6. The method of claim 1, wherein the unlabeled dataset is related to a bug tracking system, and the one or more data records comprise at least one of a description of a corresponding bug, a time of the corresponding bug, a severity of the corresponding bug, or an instruction on how to reproduce the corresponding bug.

7. The method of claim 1, further comprising:
determining a size of the unlabeled dataset; and
responsive to determining that the size of the unlabeled dataset satisfies a threshold criteria, identifying a subset of the unlabeled dataset using a sampling algorithm.

8. A system comprising:
a memory; and
a processing device of a computer system operatively coupled to the memory, the processing device to:
receive an unlabeled dataset comprising one or more data records;
divide the unlabeled dataset into a plurality of groups;
generate, for each group of the plurality of groups, a corresponding label;
generate a labeled dataset by assigning, to each group of the plurality of groups, the corresponding label; and
classify the labeled dataset using a classification model.

9. The system of claim 8, wherein the processing device is further to:
determine a number of the plurality of groups comprises by identifying an elbow of a variation of the unlabeled dataset as a function of the number of groups.

10. The system of claim 8, wherein to divide the unlabeled dataset into the plurality of groups the processing device is further to:
responsive to determining that a data record is associated with two or more groups, dividing the unlabeled dataset into a plurality of sets of groups, wherein each set of the plurality of sets of groups comprises a different combination of data records.

11. The system of claim 8, wherein to divide the unlabeled dataset into the plurality of groups, the processing device is further to: apply at least one of k-means clustering, density-based spatial clustering of applications with noise (DBSCAN), or agglomerative hierarchical clustering.

12. The system of claim 8, wherein to generate the labeled dataset by assigning, to each group of the plurality of groups, the corresponding label further comprises:
responsive to determining that a data record is associated with two or more groups, assign the corresponding labels associated with the two or more groups to the data record.

13. The system of claim 8, wherein the unlabeled dataset is related to a bug tracking system, and the one or more data records comprise at least one of a description of a corresponding bug, a time of the corresponding bug, a severity of the corresponding bug, or an instruction on how to reproduce the corresponding bug.

14. A non-transitory computer-readable media storing instructions that, when executed, cause a processing device to:
receive an unlabeled dataset comprising one or more data records;
divide the unlabeled dataset into a plurality of groups;
generate, for each group of the plurality of groups, a corresponding label;
generate a labeled dataset by assigning, to each group of the plurality of groups, the corresponding label; and
classifying the labeled dataset using a classification model.

15. The non-transitory computer-readable media of claim 14, wherein the processing device is further to: determine a number of the plurality of groups by identifying an elbow of a variation of the unlabeled dataset as a function of the number of groups.

16. The non-transitory computer-readable media of claim 14, wherein to divide the unlabeled dataset into the plurality of groups, the processing device is further to:
responsive to determining that a data record is associated with two or more groups, dividing the unlabeled dataset into a plurality of sets of groups, wherein each set of the plurality of sets of groups comprises a different combination of data records.

17. The non-transitory computer-readable media of claim 14, wherein to divide the unlabeled dataset into the plurality of groups, the processing device is further to: apply at least one of k-means clustering, density-based spatial clustering of applications with noise (DBSCAN), or agglomerative hierarchical clustering.

18. The non-transitory computer-readable media of claim 14, wherein to generate the labeled dataset by assigning, to each group of the plurality of groups, the corresponding label further comprises:
responsive to determining that a data record is associated with two or more groups, assign the corresponding labels associated with the two or more groups to the data record.

19. The non-transitory computer-readable media of claim 14, wherein the unlabeled dataset is related to a bug tracking system, and the one or more data records comprise at least one of a description of a corresponding bug, a time of the corresponding bug, a severity of the corresponding bug, or an instruction on how to reproduce the corresponding bug.

20. The non-transitory computer-readable media of claim 14, wherein the processing device is further to:
determine a size of the unlabeled dataset; and
responsive to determining that the size of the unlabeled dataset satisfies a threshold criteria, identify a subset of the unlabeled dataset using a sampling algorithm.
